(19) United States
(12) Patent Application Publication
(10) Pub. No.: US 2026/0346120 A1
(43) Pub. Date: Nov. 5, 2026

(54) COMBINATORIAL PUZZLE GAMES AND METHODS OF PLAYING COMBINATORIAL PUZZLE GAMES

(71) Applicant: Expert Eye Consulting Ltd., Dundas (CA)

(72) Inventor: Yaron Levgoren, Dundas (CA)

(21) Appl. No.: 19/112,515

(22) PCT Filed: Sep. 15, 2023
(86) PCT No.: PCT/CA2023/051233

§ 371 Date: Mar. 17, 2025

Related U.S. Application Data
(60) Provisional application No. 63/407,296, filed on Sep. 16, 2022.

(51) Int. Cl. A63F 3/00; A63F 3/04; A63F 13/52

(52) U.S. Cl. CPC A63F 3/00176; A63F 3/00697; A63F 3/0415; A63F 13/52; A63F 2003/00208; A63F 2003/00835; A63F 2003/00996; A63F 2003/0418

(57) ABSTRACT

An apparatus for playing a combinatorial number puzzle game is described herein. The apparatus includes a framework having: a centerpiece; nine rays extending outwardly from the centerpiece and a plurality of tiles. Each ray has a set of retainers, each retainer being equally spaced apart along the ray. Collectively, retainers of an equal distance from the centerpiece form a ring of retainers around the centerpiece. The retainers collectively form at least three rings of retainers. The retainers also form at least three cells on the framework. Each tile is placed on the retainers of the rays to solve the combinatorial number puzzle game. Computer systems for playing a combinatorial number puzzle game are also described herein.

### TECHNICAL FIELD

This disclosure relates generally to puzzle games, and, more specifically, to combinatorial puzzle games and methods of playing combinatorial puzzle games, optionally with added hidden features and randomness.

### BACKGROUND

Combinatorial puzzle games are games that typically involve complete information with no hidden features and no randomness. Combinatorial puzzle games are sometimes referred to as pure strategy games.

Sudoku is a logic-based, combinatorial number-placement puzzle game typically played on a grid of 9 by 9 spaces Within the rows and columns are 9 squares, each square being made up of 3 by 3 spaces. Each row, column and square needs to be filled out with the numbers 1 to 9, without repeating any numbers within any single row, column or square. Sudoku may also be played on a 12 by 12, 16 by 16, and 25 by 25 grids with similar rules.

One attraction of Sudoku puzzles is that the completion rules are simple, yet the reasoning to reach a solution may be difficult. A so-called “well-formed” Sudoku puzzle has only one solution. Further, there are a few ways that Sudoku can be played where players are rewarded during, or at the end, of the game for their speed and accuracy when placing tiles according to the basic Sudoku rules.

Other combinatorial puzzle games have been developed but have not been able to replicate the simple rules and concepts present in Sudoku.

Accordingly, there is a need for new combinatorial puzzle games and methods of playing combinatorial puzzle games that provide for players to either reach a single solution or one of many acceptable solutions.

### SUMMARY

In accordance with a broad aspect, an apparatus for playing a combinatorial number puzzle game is described herein. The apparatus includes a framework having: a centerpiece; nine rays extending outwardly from the centerpiece, each ray having a set of retainers thereon, the retainers of each set of retainers being equally spaced apart along the ray, each retainer of each ray spaced apart from the centerpiece by a same distance forming a ring of retainers around the centerpiece, the retainers of the nine rays collectively forming at least three rings of retainers of the framework, the retainers of the rays also forming three cells of the framework, each cell being formed by three adjacent rays of the nine rays and three retainers on each of the three adjacent rays; and a plurality of tiles, each tile having one of a number of colors, the number of colors being equal to a number of rays of the framework, each tile being configured to be retained on the retainers of the rays.

In at least one embodiment, the set of retainers of each ray includes three retainers and the framework includes three rings.

In at least one embodiment, the plurality of tiles includes three groups of tiles, each group of tiles having different sizes, a first group of tiles being sized to fit on a first ring of the three rings, a second group of tiles being sized to fit on a second ring of the three rings, and a third group of tiles being sized to fit on a third ring of the three rings.

In at least one embodiment, the set of retainers of each ray includes six retainers.

In at least one embodiment, the plurality of tiles include six groups of tiles, each group of tiles having different sizes, a first group of tiles being sized to fit on a first ring of the six rings, a second group of tiles being sized to fit on a second ring of the six rings, a third group of tiles being sized to fit on a third ring of the six rings, a fourth group of tiles being sized to fit on a fourth ring of the six rings, a fifth group of tiles being sized to fit on a fifth ring of the six rings, and a sixth group of tiles being sized to fit on a sixth ring of the six rings.

In at least one embodiment, each of the nine rays includes two ray portions configured to attach to each other, each portion of each ray being a different color than the other portion of the same ray.

In at least one embodiment, the set of retainers of each ray includes nine retainers.

In at least one embodiment, the plurality of tiles include nine groups of tiles, each group of tiles having different sizes, a first group of tiles being sized to fit on a first ring of the nine rings, a second group of tiles being sized to fit on a second ring of the nine rings, a third group of tiles being sized to fit on a third ring of the nine rings, a fourth group of tiles being sized to fit on a fourth ring of the nine rings, a fifth group of tiles being sized to fit on a fifth ring of the nine rings, a sixth group of tiles being sized to fit on a sixth ring of the nine rings, a seventh group of tiles being sized to fit on a seventh ring of the nine rings, an eighth group of tiles being sized to fit on a eighth ring of the nine rings, and a ninth group of tiles being sized to fit on a ninth ring of the nine rings.

In at least one embodiment, each of the nine rays includes three portions configured to attach to each other, each portion of each ray being a different color than the other portions of the same ray.

In at least one embodiment, each of the retainers is a post extending upwardly from the rays.

In at least one embodiment, each tile includes an aperture shaped to fit around the post of the retainers.

In at least one embodiment, each ray is configured to be removably attached to the centerpiece.

In at least one embodiment, two adjacent cells are a different color from each other.

In at least one embodiment, the centerpiece is circular.

In at least one embodiment, the apparatus further includes a plurality of markers configured to identify a player of the game.

In at least one embodiment, the markers are one of: washers configured to be placed on the retainers, stickers configured to be positioned on the tiles, or elastics configured to be positioned on the tiles.

In at least one embodiment, each tile is personalized to a player of the game.

In accordance with another broad aspect, a non-transitory computer-readable medium comprising executable instructions for causing a computer system to provide an apparatus for playing a combinatorial number puzzle game is described herein. The combinatorial number puzzle includes a framework having: a centerpiece; nine rays extending outwardly from the centerpiece, each ray having a set of retainers thereon, the retainers of each set of retainers being equally spaced apart along the ray, each retainer of each ray spaced apart from the centerpiece by a same distance forming a ring of retainers around the centerpiece, the retainers of the nine rays collectively forming at least three rings of retainers of the framework, the retainers of the rays also forming three cells of the framework, each cell being formed by three adjacent rays of the nine rays and three retainers on each of the three adjacent rays; and a plurality of tiles, each tile having one of a number of colors, the number of colors being equal to a number of rays of the framework, each tile being configured to be retained on the retainers of the rays and placed according to its size.

In at least one embodiment, the framework is a board.

In accordance with another broad aspect, a method of playing a combinatorial number puzzle game is described herein. The method includes positioning a first tile on a first retainer of a framework of an apparatus according to at least one embodiment described herein; positioning a second tile on a second retainer of the framework of the apparatus according to at least one embodiment described herein; and continuing to position subsequent tiles on the retainers until each retainer of each ring, each retainer of each ray, and each retainer of each cell has one tile without repeating any colors within any single ray, ring and cell or until no player can place a tile on any retainer in accordance with these rules.

In at least one embodiment, before positioning the first tile on the first retainer, positioning a plurality of tiles on the framework, each tile positioned on a respective retainer to partially fill the framework and establish a starting point for solving the puzzle game.

In at least one embodiment, one player performs the steps of the methods described herein.

In at least one embodiment, two or more players perform the steps of the methods described herein simultaneously.

In at least one embodiment, two or more players take turns performing steps of the methods described herein.

In accordance with another broad aspect, an apparatus for playing a combinatorial number puzzle game is described herein. The apparatus includes a framework having nine rays extending outwardly from the centerpiece, each ray having a set of spaces, the spaces of each set of spaces being equally spaced apart along the ray. Each space of each ray is spaced apart from the centerpiece by a same distance. A respective space on each ray forms a ring of spaces around the centerpiece. The spaces of the nine rays collectively form at least three rings of spaces of the framework. The spaces of the rays also form three cells of the framework, each cell being formed by three adjacent rays of the nine rays and three spaces on each of the three adjacent rays.

In at least one embodiment, the apparatus may be electronically enabled and the framework may be displayed on a screen of the device.

In at least one embodiment, each space of the framework may be filled with a color to solve the combinatorial number puzzle game.

In at least one embodiment, a plurality of tiles may be included with the apparatus, each tile having one of a number of colors, the number of colors being equal to a number of rays of the framework.

In accordance with another broad aspect, a system for playing a combinatorial number puzzle game is described herein. The system includes a board having: a processor; a data storage component in electrical communication with the processor; a communication component in electrical communication with the processor, the communication component being configured to communicate with at least one external computing device; and a display screen in electrical communication with the processor, the processor configured to display a framework, the framework having nine rays extending outwardly from the centerpiece, each ray having a set of spaces, the spaces of each set of spaces being equally spaced apart along the ray. Each space of each ray is spaced apart from the centerpiece by a same distance. A respective space on each ray forms a ring of spaces around the centerpiece. The spaces of the nine rays collectively form at least three rings of spaces of the framework. The spaces of the rays also form three cells of the framework, each cell being formed by three adjacent rays of the nine rays and three spaces on each of the three adjacent rays.

In accordance with another broad aspect, a non-transitory computer-readable medium comprising executable instructions for causing the system of claim 26 to provide the board on the display screen.

These and other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1 is a top view of a framework of an apparatus of a combinatorial puzzle game, according to at least one embodiment described herein.

FIG. 2 is a top view of a framework of another apparatus of a combinatorial puzzle game, according to at least one embodiment described herein.

FIG. 3 is a top view of a framework of another apparatus of a combinatorial puzzle game, according to at least one embodiment described herein.

FIG. 4 is a top view of a framework of another apparatus of a combinatorial puzzle game, according to at least one embodiment described herein.

FIG. 5 is a perspective view of two sets of tiles of an apparatus of a combinatorial puzzle game, according to at least one embodiment described herein.

FIG. 6 is a top view of the framework of FIG. 4 having a plurality of tiles positioned thereon, according to at least one embodiment described herein.

FIG. 7 is a block diagram of an electronic device for implementing a combinatorial puzzle game, according to at least one embodiment described herein.

FIG. 8 is a top view of a plurality of puzzle cards generated by a computer program implementing the combinatorial puzzle games described herein, according to at least one embodiment described herein.

FIG. 9 is a top view of a plurality of clue cards generated by a computer program implementing the combinatorial puzzle games described herein, according to at least one embodiment described herein.

FIG. 10 is a top view of a framework of another apparatus of a combinatorial puzzle game, according to at least one embodiment described herein.

FIG. 11 is a top view of a framework of another apparatus of a combinatorial puzzle game, according to at least one embodiment described herein.

FIG. 12 is a block diagram of an apparatus for implementing a combinatorial puzzle game, according to at least one embodiment described herein.

Further aspects and features of the example embodiments described herein will appear from the following description taken together with the accompanying drawings.

### DETAILED DESCRIPTION

Various systems, devices and methods are described below to provide an example of at least one embodiment of the claimed subject matter. No embodiment described below limits any claimed subject matter and any claimed subject matter may cover systems, devices and methods that differ from those described below. The claimed subject matter are not limited to systems, devices and methods having all of the features of any one systems, device or method described below or to features common to multiple or all of the systems, devices and methods described below. It is possible that a system, device or method described below is not an embodiment of any claimed subject matter. Any subject matter that is disclosed in a system, device or method described herein that is not claimed in this document may be the subject matter of another protective instrument, for example, a continuing patent application, and the applicant(s), inventor(s) and/or owner(s) do not intend to abandon, disclaim, or dedicate to the public any such invention by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

It should be noted that terms of degree such as “substantially”, “about” and “approximately” as used herein mean a reasonable amount of deviation of the modified term such that the end result is not significantly changed. These terms of degree should be construed as including a deviation of the modified term, such as 1%, 2%, 5%, or 10%, for example, if this deviation does not negate the meaning of the term it modifies.

Furthermore, the recitation of any numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation up to a certain amount of the number to which reference is being made, such as 1%, 2%, 5%, or 10%, for example, if the end result is not significantly changed.

The following description is not intended to limit or define any claimed or as yet unclaimed subject matter. Subject matter that may be claimed may reside in any combination or sub-combination of the elements or process steps disclosed in any part of this document including its claims and figures. Accordingly, it will be appreciated by a person skilled in the art that an apparatus (i.e. board), system or method disclosed in accordance with the teachings herein may embody any one or more of the features contained herein and that the features may be used in any particular combination or sub-combination that is physically feasible and realizable for its intended purpose.

Recently, there has been a growing interest in developing new and improved combinatorial puzzle games and methods of playing combinatorial puzzle games.

Herein, various embodiments of a combinatorial puzzle game are described. Each of the embodiments requires specific placement of a plurality of tiles in relation to each other. The plurality of tiles have various sizes and colors and are arranged relative to each other based on their size and color.

While Sudoku is most commonly played on a grid of 9 by 9 squares, the combinatorial games described herein are played on a framework having rays extending outwardly from a centerpiece. The combinatorial games described herein may be played by arranging tiles having 9 different colors within the rays, rings and cells of the framework, each ray, ring and cell needing to be filled out with tiles without repeating any colors of tiles within any single ray, ring and cell. It should be understood that the term “framework” as used herein encompasses and includes the term “board”. Further, it should be understood, particularly in a digital version of the game, described in greater detail below, the framework described herein may be a board and the tiles described herein may be positioned relative to markings on the board.

It should be understood that the combinatorial puzzle games described herein are shown as being played on a framework having nine rays extending outwardly from a centerpiece. However, different variations of the combinatorial puzzle games may include having 12, 16 or 25 rays extending outwardly from a centerpiece.

Further, it should also be understood that although the combinatorial puzzle games described herein are shown as being played within three dimensions (i.e., by placing tiles within rays, rings and cells), it should be understood that the combinatorial games described herein may also be played within a fourth dimension, where tiles are stacked on top of each other, such as but not limited to being stacked according to their size.

It should also be understood that the term “retainer” herein is used to refer to a position along the ray where a tile can be placed. The term “retainer” includes a thing that is configured to hold a tile in place, however should not be limited to being a thing that holds a tile in place. The term “retainer” may also, in a two-dimensional version of the framework (e.g., a board), refer to a position along a ray having a boundary to indicate a location for placing a tile.

The games described herein may also be played in an electronic form, where the “framework” or “board” is a two dimensional or three-dimensional representation of a physical object.

The games described herein may also be played as a combination of a physical game board and an electronic form. In these embodiments, for example, the board may be physical board that is electronically enabled. The board may include a processor and a communication component to communicate with a computing device (e.g., a mobile device) controlled by a player. In at least one embodiment, an application (e.g. mobile) running on the computing device may be used by the player to control the color of tiles positioned on the board. In this case, the board may include a display and the framework may be shown on the display. Electronic representations of tiles, or spaces may be electronically filled with different colors, by users in control of the application running on the computing devices. As is well understood, the board could be configured to communicate with more than on computing device running an application to control the appearance of the board and, thus, play the combinatorial puzzle game. These embodiments are described in greater detail below.

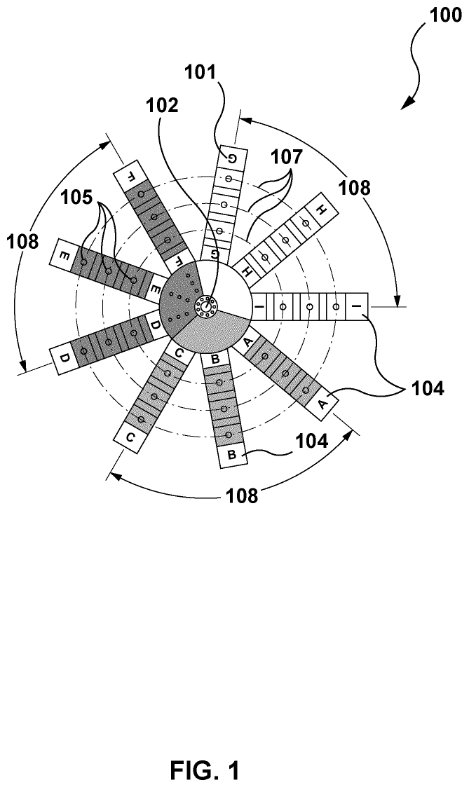

Referring now to FIG. 1, a framework 101 of an apparatus 100 for playing a combinatorial puzzle game is shown therein. Framework 101 includes a centerpiece 102 and nine rays 104 extending outwardly from centerpiece 102. In the examples shown in FIGS. 1-4 and 6, each of the rays 104 extends a same distance from centerpiece 102 as each other ray 104. Further, in the examples shown in FIGS. 1-4 and 6, each of the rays 104 is arranged to form an equal angle with an adjacent ray 104 at the centerpiece 102. In the embodiments shown in the drawings, each of the rays 104 is identified by a letter from A to I. This may help players identify a specific ray 104 while playing the game.

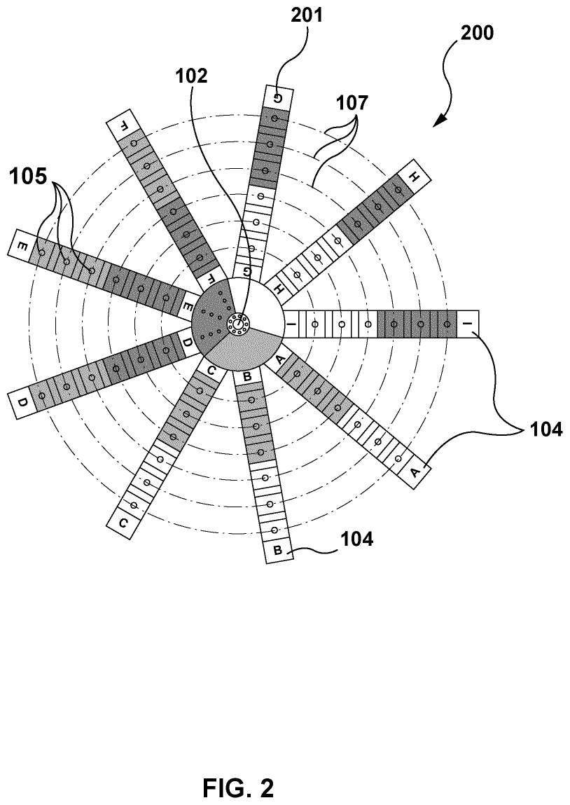

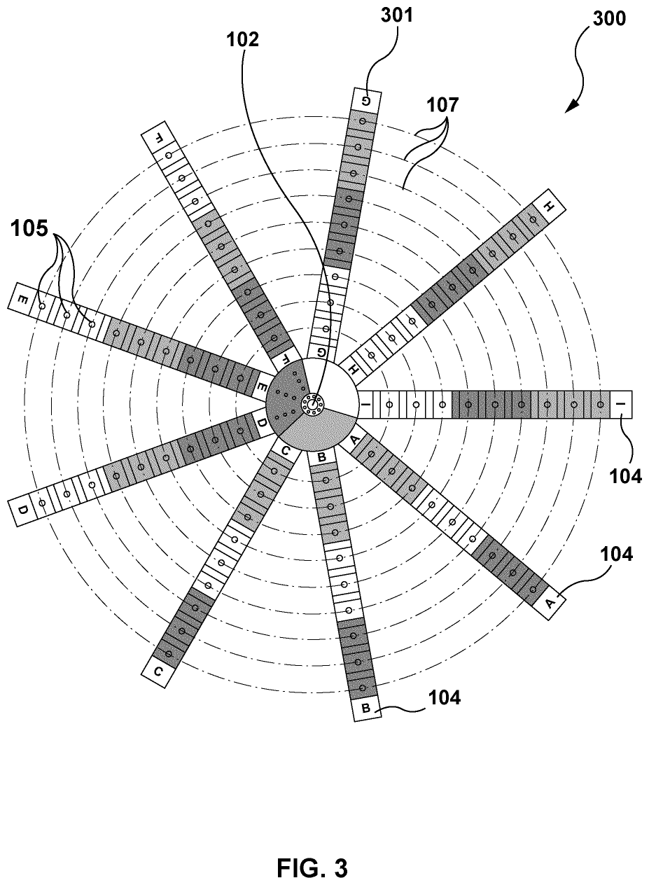

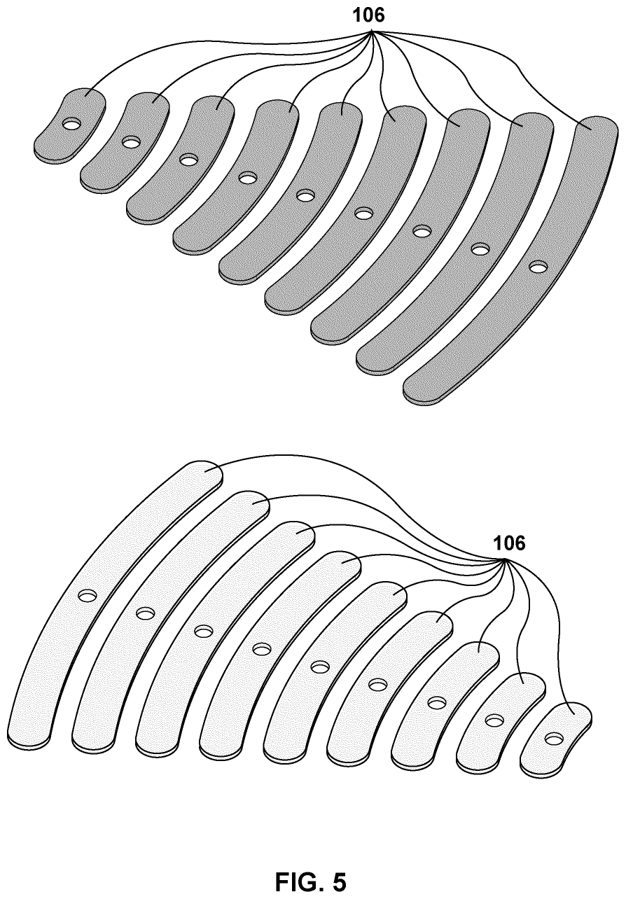

Each ray 104 has a plurality of retainers 105 thereon that are each configured to support at least one tile 106 thereon. As noted above, in some embodiments, the retainers 105 may be configured to support more than one tile 106 thereon, for example if more than one tile 106 was stacked on top of each other. In the embodiment shown in FIG. 1, each ray 104 has three retainers 105 thereon, each retainer 105 being configured to support at least one tile 106 (see FIG. 5). Conversely, in the embodiment shown in FIG. 2, each ray 104 has six retainers 105 thereon, each retainer 105 being configured to support at least one tile 106. In the embodiment shown in FIG. 3, each ray 104 has nine retainers 105 thereon, each retainer 105 being configured to support at least one tile 106. In some embodiments, the retainers may be marked labelled to identify the retainers, such as but not limited to being marked with a number representing each ring (for example, the numbers 1-9 as shown in the figures).

In at least one embodiment, each retainer 105 is a post extending upwardly from a body of ray 104. In these embodiments, the post is configured to co-operate with a tile 106 to support the tile 106 on the ray 104 and retain the tile 106 on the ray 104. For example, in the embodiments shown, each tile 106 includes an aperture to receive retainer 105. It should be understood that each tile 106 may be configured in another manner to co-operate with retainer 105, and that retainer 105 may be configured in another manner to support and retain at least one tile 106 on ray 104.

Each retainer 105 that is spaced apart from the centerpiece 102 by a same distance along a ray 104 forms a ring 107 of retainers 105 around the centerpiece 102. FIG. 1 shows that the three retainers 105 of each ray 104 form three rings 107 around the centerpiece 102.

FIG. 2 shows a framework 201 where each ray 104 includes six retainers 105 forming six rings 107 around the centerpiece 102.

FIG. 3 shows a framework 301 where each ray 104 includes nine retainers 105 forming nine rings 107 around the centerpiece 102.

Returning to FIG. 1, the rays 104 are shown as forming three cells 108 of the apparatus 100. Each cell 108 is formed by three adjacent rays 104, each of the rays 104 have three retainers 105 thereon. Accordingly, in this example, each cell 108 includes 9 retainers 105. Each cell 108 is differentiated from the other cells 108 by each ray 104 of a same cell 108 being a same color, and each cell 108 having rays 104 having a different color than rays 104 of the other cells 108. In the example shown, the cells 108 are identified by the following colors: red, white and dark grey.

In the embodiment shown in FIG. 2, the rays 104 are shown as forming six cells 108 of the apparatus 200. Each cell 108 is again formed by three adjacent rays 104 (i.e. A, B, C-D, E, F-G, H, I), each of the cells having three adjacent retainers 105 of each of three adjacent rays 104. Accordingly, again, each cell 108 includes 9 retainers 105. Also, again, each cell 108 is differentiated from the other cells 108 by each portion of each ray 104 of a same cell 108 being a same color, and each cell 108 having a portion of rays 104 having a different color than portions of rays 104 of adjacent other cells 108. In the example shown, the cells 108 are identified by the following colors: red, white and dark grey.

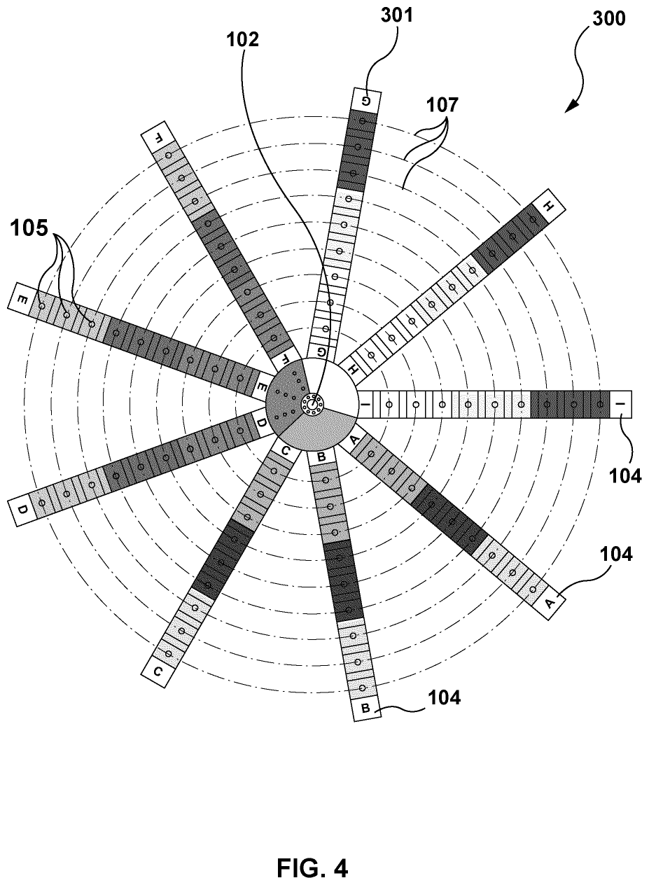

In the embodiment shown in FIG. 4, the rays 104 are shown as forming nine cells 108 of the apparatus 200. Each cell 108 is again formed by three adjacent rays 104, each of the cells having three adjacent retainers 105 of each of three adjacent rays 104. Accordingly, again, each cell 108 includes 9 retainers 105. Also, again, each cell 108 is differentiated from the other cells 108 by each portion of each ray 104 of a same cell 108 being a same color, and each cell 108 having a portion of rays 104 having a different color than portions of rays 104 of the other cells 108. In the example shown, the cells 108 are identified by the following colors: brown, blue green, pink, red, yellow, orange, white and dark grey. In order to limit sensory overload, it may be desirable to only use three different colors to create the nine different cells.

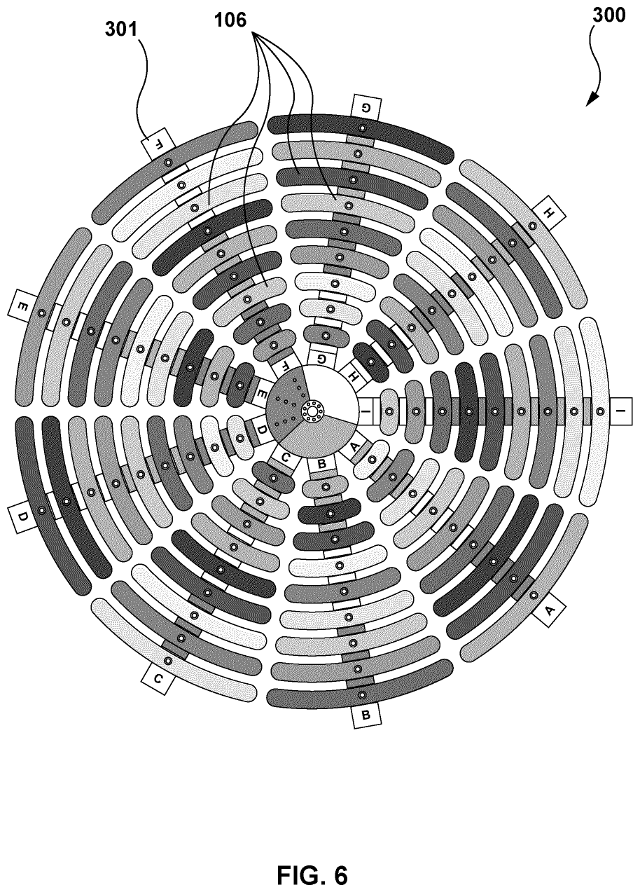

Turning to FIG. 5, apparatuses 100, 200 and/or 300 each also include a plurality of tiles 106. Each tile 106 has one of a number of colors, the number of colors being equal to a number of rays of the framework of a respective apparatus. For example, as shown in FIG. 1, the apparatus 100 includes nine rays 104 and three rings 107. Accordingly, to play a combinatorial puzzle game with the apparatus 100 of FIG. 1, the tiles 106 shall have nine different colors. Similarly the apparatus 200 includes nine rays 104 and six rings 107, so to play a combinatorial puzzle game with the apparatus 200 of FIG. 2, the tiles 106 shall have nine different colors. Similarly the apparatus 300 includes nine rays 104 and nine rings 107, so to play a combinatorial puzzle game with the apparatus 300 of FIG. 3, the tiles 106 shall have nine different colors. In the example show on FIG. 6, an example of apparatus 300 is shown with framework 301 and a plurality of tiles 106 having nine different colors.

Each tile 106 is configured to be retained on a retainer 105 of a ray 104.

In the examples shown herein, the tiles 106 have various sizes. More specifically, the plurality of tiles 106 collectively have a number of sizes equal to a number of rings of the framework 101. For example, playing a game with framework 101 requires that the tiles 106 collectively have three different sizes. In at least one embodiment, the tiles 106 are arranged on the rays 104 such that the tiles 106 increase in size in a direction beginning at the centerpiece 102 and extending outward therefrom.

Similarly, playing a game with framework 201 requires that the tiles 106 collectively have six different sizes and playing a game with framework 301 requires that the tiles 106 collectively have nine different sizes. As previously described with reference to framework 101, when playing a game with either of framework 201 or framework 301, the tiles 106 are arranged on the rays 104 such that the tiles 106 increase in size in a direction beginning at the centerpiece 102 and extending outward therefrom.

In at least one embodiment, an identifier may be added to the tiles to indicate that a specific player of the game placed the tile at a given position. The indicator may be an elastic, a magnet, a colored pin, a sticker or any other object that can be releasable retained on the tile and capable of indicating a player of the game. For example, in at least one embodiment, the identifier may be a sticker and each player of the game may be assigned a sticker having a unique color in order to identify tiles that they have placed.

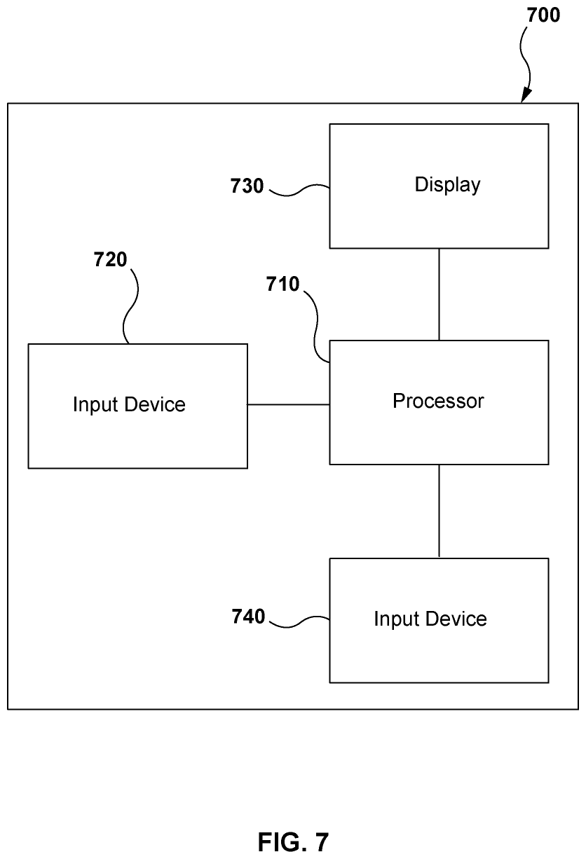

The combinatorial puzzle games may also be implemented by an electronic device, such as a computer, by way of computer executable software code. Referring to FIG. 7, an electronic device 700 for implementing the combinatorial puzzle games described herein is shown. A processor 710 is configured to execute software code stored in memory 720. A display 730, preferably a graphical user interface (GUI), displays the apparatus including the framework and tile to a player. A player uses input device 540 to manipulate and place the tiles represented graphically on the display 530. Where the electronic device 700 is a personal computer, the input device 740 is preferably a keyboard or a mouse. Where the electronic device 700 is a stand-alone game unit or a portable electronic device (e.g., a smartphone or tablet), the input device 740 may be action keys, or the display 730 may incorporate a pressure sensitive touch screen. The distinctive tiles may be represented graphically on the display 730 using icons. Players would interface with the electronic apparatus via a user interface. Selection of tiles and locations for a player's turn may be selected by way of the user interface.

It should be understood that the combinatorial puzzle games described herein as being implemented on a computer may be played on a framework having nine rays extending outwardly from a centerpiece or, alternatively, 12, 16 or 25 rays extending outwardly from a centerpiece.

The combinatorial puzzle games described herein can be implemented in a computer program tangibly embodied in a computer-readable storage medium containing a set of instructions for execution by a processor or a general purpose computer; and method steps of the invention can be performed by a processor executing a program of instructions to perform functions of the invention by operating on input data and generating output data. Suitable processors include, by way of example, both general and special purpose processors. Typically, a processor will receive instructions and data from a ROM, a random access memory (RAM), and/or a storage device. Storage devices suitable for embodying computer program instructions and data include all forms of non-volatile memory, including by way of example semiconductor memory devices, magnetic media such as internal hard disks and removable disks, magneto-optical media, and optical media such as CD-ROM disks and digital versatile disks (DVDs). In addition, while the illustrative embodiments may be implemented in computer software, the functions within the illustrative embodiments may alternatively be embodied in part or in whole using hardware components such as Application Specific Integrated Circuits (ASICs), Field Programmable Gate Arrays (FPGAs), or other hardware, or in some combination of hardware components and software components.

The example embodiments of the devices, systems, or methods described in accordance with the teachings herein may be implemented as a combination of hardware and software. For example, the embodiments described herein may be implemented, at least in part, by using one or more computer programs, executing on one or more programmable devices comprising at least one processing element and at least one storage element (i.e., at least one volatile memory element and at least one non-volatile memory element). The hardware may comprise input devices including at least one of a touch screen, a keyboard, a mouse, buttons, keys, sliders, and the like, as well as one or more of a display, a printer, and the like depending on the implementation of the hardware.

It should also be noted that there may be some elements that are used to implement at least part of the embodiments described herein that may be implemented via software that is written in a high-level procedural language such as object oriented programming. The program code may be written in C++, C#, JavaScript, Python, or any other suitable programming language and may comprise modules or classes, as is known to those skilled in object-oriented programming. Alternatively, or in addition thereto, some of these elements implemented via software may be written in assembly language, machine language, or firmware as needed. In either case, the language may be a compiled or interpreted language.

At least some of these software programs may be stored on a computer readable medium such as, but not limited to, a ROM, a magnetic disk, an optical disc, a USB key, and the like that is readable by a device having a processor, an operating system, and the associated hardware and software that is necessary to implement the functionality of at least one of the embodiments described herein. The software program code, when read by the device, configures the device to operate in a new, specific, and predefined manner (e.g., as a specific-purpose computer) in order to perform at least one of the methods described herein.

At least some of the programs associated with the devices, systems, and methods of the embodiments described herein may be capable of being distributed in a computer program product comprising a computer readable medium that bears computer usable instructions, such as program code, for one or more processing units. The medium may be provided in various forms, including non-transitory forms such as, but not limited to, one or more diskettes, compact disks, tapes, chips, and magnetic and electronic storage. In alternative embodiments, the medium may be transitory in nature such as, but not limited to, wire-line transmissions, satellite transmissions, internet transmissions (e.g., downloads), media, digital and analog signals, and the like. The computer useable instructions may also be in various formats, including compiled and non-compiled code.

### Methods of Playing Games

There are many different variations in how the above-described apparatuses can be used to play a combinatorial puzzle game. As noted above, each of the games described herein are played by arranging tiles having 9 different colors within the rays, rings and cells on the frameworks described above, each ray, ring and cell needing to be filled out without repeating any colors within any single ray, ring and cell. Several variations of how to play combinatorial puzzle games are described below.

In at least one embodiment, the apparatuses described herein may be used to play a single-player combinatorial puzzle game. For example, in at least one embodiment, a plurality of tiles may be placed within the rays, rings and cells on the frameworks as clues for a player to start to solve the puzzle. A player may then select and place tiles on the framework to achieve the goal of each ray, ring and cell needing to be filled out without repeating any colors within any single ray, ring and cell.

In at least one embodiment, the apparatuses described herein may be used to play a multi-player combinatorial puzzle game. For example, in at least one embodiment, a plurality of tiles may be placed within the rays, rings and cells on the frameworks as clues for the players to start to solve the puzzle. Players may then take turns selecting and placing tiles on the framework to achieve the goal of each ray, ring and cell being filled out without repeating any colors within any single ray, ring and cell. In some embodiments, the players may select tiles to be placed on the framework from a common pool of tiles. In some embodiments, the players can be assigned specific tiles and the players may only choose to place tiles that they have been assigned. In some embodiments, the players may be assigned specific tiles and there may be a common pool of tiles, and the players may choose to place a tile that has been assigned to them or, if they are unable to place a tile that has been assigned to them, they may choose to place a tile from the common pool of tiles. In some cases, players that are unable to place a tile, either within a specified time frame or because they are unable to comply with the goal of each ray, ring and cell needing to be filled out without repeating any colors within any single ray, ring and cell, are removed from the game.

In at least one embodiment, additional elements may be introduced to the combinatorial puzzle game to, for example, increase or decrease complexity of the game. For example, clue sheets may be provided to allow a player of the game to see a solution, or a partial solution, of the puzzle while playing the game. For example, a clue sheet may indicate a correct arrangement of tiles on a ray, ring or cell of the framework to achieve a solution to a specific puzzle.

In at least one embodiment, tokens may be provided for use by players playing that game that wish to make wagers on the correctness of placement of specific tiles on the framework.

In at least one embodiment, for both the physical and the digital versions of the combinatorial puzzle games described herein, a computer program can be implemented to create combinatorial puzzle games, defining the number of anchor tiles and/or generating corresponding clue sheets for use in solving the combinatorial puzzle games.

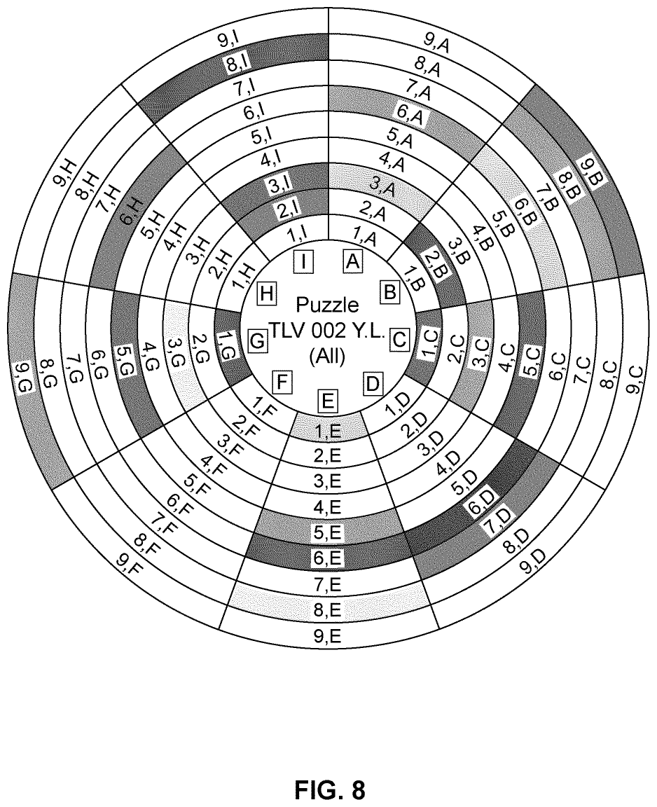

With regards to creating combinatorial puzzle games, in at least one embodiment, the computer program can be programmed and implemented to create puzzle cards providing a starting point for players to play combinatorial puzzle games. The puzzle cards show the color and position of a selected number of tiles within rings, rays and/or cells of the boards described herein for a player to start playing a specific combinatorial puzzle game. The tiles shown on the puzzle cards are referred to as anchors. The computer program may be programmed to generate and display puzzle cards such as the ones shown in FIG. 8., for example. In at least one embodiment, a player can then position tiles on a framework according to at least one embodiment described herein so that the tiles on the framework mimic the position and color of the tiles on the puzzle cards. The puzzle cards may be used in the physical and/or digital versions of the combinatorial puzzle game.

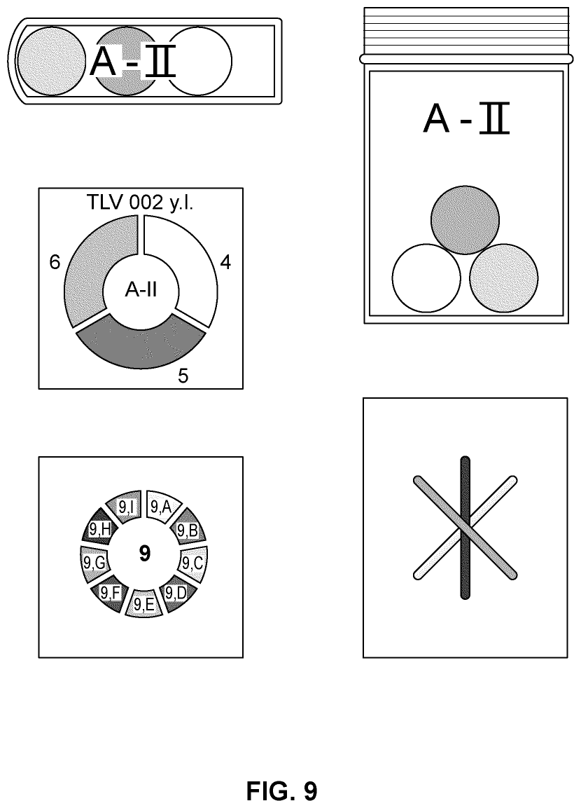

With regards to creating combinatorial puzzle games, in at least one embodiment, the computer program can be programmed and implemented to create clue cards providing hints for players playing combinatorial puzzle games. The computer program may be programmed to generate and display clue cards such as the ones shown in FIG. 9., for example. The clue cards show the color and/or position of at least some of the tiles within rings, rays and/or cells of the boards described herein for a player solving a specific combinatorial puzzle game. More specifically, the three clue cards shown on the left of FIG. 9 show position and colour and the two clue cards shown on the right of FIG. 9 show colour only without position. The two example clue cards shown at the top of FIG. 9, the bag and stick clue cards, can also be created by the players in the analog game. In at least one embodiment, when the board includes 81 tiles, 27 clue cards may be provided, each clue card providing a color and/or general location of three tiles on the board for a player to use when solving the combinatorial puzzle game. It should be understood that the clue cards can be generated by the computer software for use in the digital and/or the analog versions of the combinatorial puzzle game described herein.

In another example, the computer program implementing the combinatorial puzzle game may be programmed to provide immediate or delayed feedback to a player when the player places a tile on the board. The immediate or delayed feedback may include indicating to the player that the placement of the tile is correct or incorrect.

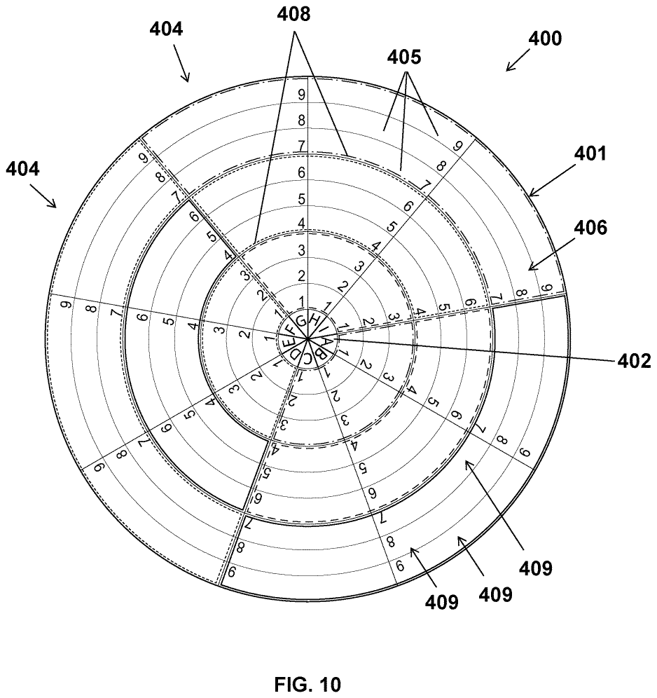

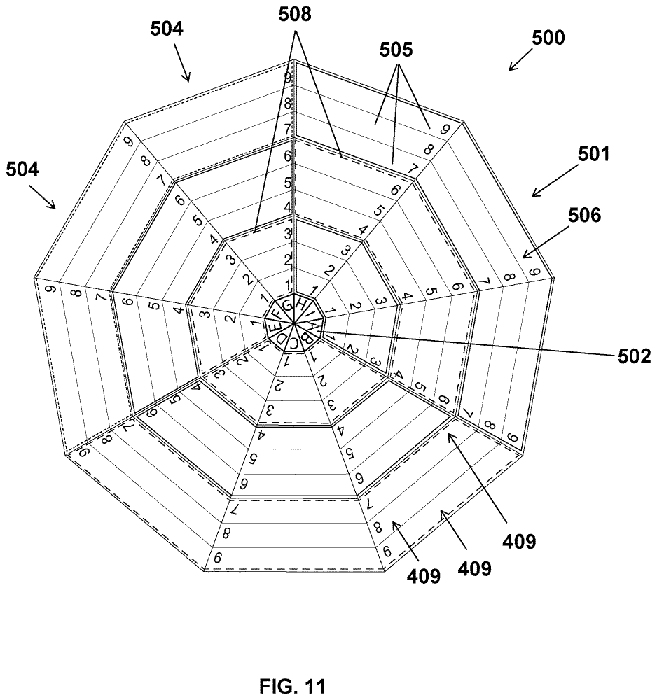

In another embodiment, the combinatorial puzzle games described herein may also be played as a combination of a physical game board and an electronic form. In these embodiments, for example, as shown in FIG. 10, a board 400 is shown. In FIG. 10, board 400 has a circular shape. Board 400 has nine lines of symmetry (defined by the rays 404). In the example shown in FIG. 11, board 500 has a nonagon shape.

In the embodiment shown in FIG. 10, board 400 includes a framework 401 having nine rays 404 extending outwardly from centerpiece 402. Each of the rays 404 extends a same distance from centerpiece 402 as each other ray 404. Further, each of the rays 404 is arranged to form an equal angle with an adjacent ray 404 at the centerpiece 402. In the embodiments shown in FIG. 10, each of the rays 404 is identified by a different letter. This may help players identify a specific ray 404 while playing the game. It should be understood, as described above with reference to earlier embodiments, other identifiers may be used. In the embodiment of FIG. 10, each ray 404 is a circular sector.

Each ray 404 has a plurality of spaces 405. Each space 405 is a portion of the circular sector formed by ray 404. Each space 405 is configured to correspond with at least one tile 406. For example, each space 405 may have a size and shape that matches at least one tile 406.

In some embodiments, board 400 may be electrically-enabled, meaning board 400 may include a display configured to display a virtual representation of a framework 401. In these embodiments, the framework 401 may be presented on the display of board 400. During gameplay, the board 400 may be communicatively coupled, e.g. over a network 428, such as a wireless network, to one or more mobile devices that can control, via, for example, a mobile application stored thereon, the appearance of tiles 406 on the framework 401. In these embodiments, tiles 406 may not be physical tiles, but an individual tile 406 may be represented when a color is applied to a space 405 area. Each tile 406 has one of a number of colors, the number of colors being equal to a number of rays 404 of the framework 401. It should be understood that, in at least one embodiment described herein, each tile 406 of a respective ring 409 has a same size. It should also be understood that tiles 406 of different respective rings 409 have a different size.

In the embodiment shown in FIG. 10, each ray 404 has nine spaces 405 spread therealong. As noted above, rays 404 may have different numbers of spaces 406 therealong. Each space 406 of each ray 404 is spaced apart from the centerpiece 402 by a same distance as a respective space on each other ray 404 to form a ring of spaces around the centerpiece. In the embodiment shown in FIG. 10, spaces 406 of the nine rays 404 collectively form nine rings 409 of spaces 405 of the framework 401. Three cells 408 are formed by the spaces 405 of three adjacent rings 409 and three adjacent rays 404.

As noted above, the board 400 may be electronically enabled and may communicate with (e.g., receive instructions from) at least one mobile device controlled by a player. In at least one embodiment, a mobile application running on the mobile device may be used by the player to control the color of tiles 406 positioned on the board 400. In this case, the board 400 may include a display screen and the framework 401 may be shown on the display screen.

In at least one embodiment, where the board 400 is electronically enabled, a processor thereof may be configured to provide for a tile 406 on the display to flash and/or otherwise indicate when a tile 406 has been positioned incorrectly. In at least one other embodiment, a processor of board 400 may reject an instruction from a player to place a tile 406 in an incorrect position on board 400.

In at least one embodiment, a digital representation of board 400 may also be provided on the mobile device communicatively connected thereto to provided for a user suing the mobile device to see the digital representation without having to look at a physical version of board 400.

In the example shown in FIG. 11, board 500 has a regular nonagon shape, thereby having nine lines of symmetry (defined by the rays 504) and rotational symmetry of order 9.

Board 500 also includes a framework 501 having nine rays 504 extending outwardly from centerpiece 502. Each of the rays 504 extends a same distance from centerpiece 502 as each other ray 504. Further, each of the rays 504 is arranged to form an equal angle with an adjacent ray 504 at the centerpiece 502. In the embodiment shown in FIG. 11, each of the rays 504 is identified by a different letter. In the embodiment of FIG. 11, each ray 504 is a nonagon sector.

Each ray 504 has a plurality of spaces 505. Each space 505 is a portion of the circular sector formed by ray 504. Each space 505 is configured to correspond with at least one tile 506. For example, each space 505 may have a size and shape that matches at least one tile 506.

In some embodiments, board 500 may be electrically-enabled, meaning board 500 may include a display configured to display a virtual representation of a framework 501. In these embodiments, the framework 501 may be presented on the display of board 500. During gameplay, the board 500 may be communicatively coupled, e.g. over a wireless network, to one or more mobile devices that can control, via, for example, a mobile application stored thereon, the appearance of tiles 506 on the framework 501. In these embodiments, tiles 506 may not be physical tiles, but an individual tile 506 may be represented when a color is applied to a space 505 area. Each tile 506 has one of a number of colors, the number of colors being equal to a number of rays 504 of the framework 501. It should be understood that, in at least one embodiment described herein, each tile 506 of a respective ring 509 has a same size. It should also be understood that tiles 506 of different respective rings 509 have a different size.

In the embodiment shown in FIG. 11, each ray 504 has nine spaces 505 spread therealong. As noted above, rays 504 may have different numbers of spaces 406 therealong. Each space 506 of each ray 504 is spaced apart from the centerpiece 502 by a same distance as a respective space on each other ray 504 to form a ring of spaces around the centerpiece. In the embodiment shown in FIG. 10, spaces 506 of the nine rays 504 collectively form nine rings 509 of spaces 505 of the framework 501. Three cells 508 are formed by the spaces 505 of three adjacent rings 509 and three adjacent rays 504.

As noted above, the board 500 may be electronically enabled and may communicate with (e.g., receive instructions from) at least one mobile device controlled by a player. In at least one embodiment, a mobile application running on the mobile device may be used by the player to control the color of tiles 506 positioned on the board 500. In this case, the board 500 may include a display screen and the framework 501 may be shown on the display screen.

In at least one embodiment, where the board 500 is electronically enabled, a processor thereof may be configured to provide for a tile 506 on the display to flash and/or otherwise indicate when a tile 506 has been positioned incorrectly. In at least one other embodiment, a processor of board 500 may reject an instruction from a player to place a tile 506 in an incorrect position on board 500.

In at least one embodiment, a digital representation of board 500 may also be provided on the mobile device communicatively connected thereto to provided for a user suing the mobile device to see the digital representation without having to look at a physical version of board 500.

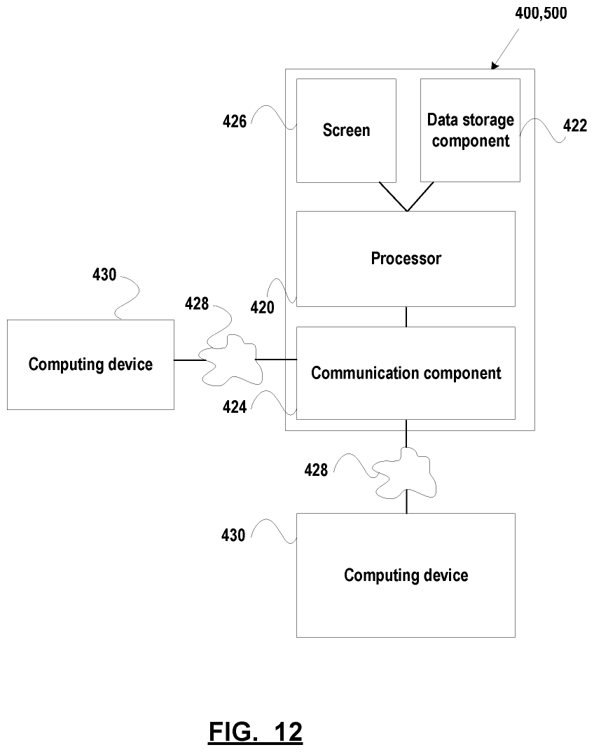

FIG. 12 is a block diagram of an apparatus 400,500 for implementing a combinatorial puzzle game, according to at least one embodiment described herein. As shown therein, the apparatus 400,500 includes a processor 420, a data storage component 422 in electrical communication with the processor 420, a communication device 424 in electrical communication with the processor 420. The communication device 424 is configured to communicate with at least one external computing device 430. The apparatus 400,500 also includes a screen 426 in electrical communication with the processor 420. Processor 420 configured to instruct the screen 426 to display any framework described or contemplated herein, including but not limited to framework 401,501.

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

1. An apparatus for playing a combinatorial number puzzle game, the apparatus comprising:
a framework having:
a centerpiece;
nine rays extending outwardly from the centerpiece, each ray having a set of retainers thereon, the retainers of each set of retainers being equally spaced apart along the ray, each retainer of each ray spaced apart from the centerpiece by a same distance forming a ring of retainers around the centerpiece, the retainers of the nine rays collectively forming at least three rings of retainers of the framework, the retainers of the rays also forming three cells of the framework, each cell being formed by three adjacent rays of the nine rays and three retainers on each of the three adjacent rays; and
a plurality of tiles, each tile having one of a number of colors, the number of colors being equal to a number of rays of the framework, each tile being configured to be retained on the retainers of the rays.

2. The apparatus of claim 1, wherein the set of retainers of each ray includes three retainers and the framework includes three rings.

3. The apparatus of claim 2, wherein the plurality of tiles includes three groups of tiles, each group of tiles having different sizes, a first group of tiles being sized to fit on a first ring of the three rings, a second group of tiles being sized to fit on a second ring of the three rings, and a third group of tiles being sized to fit on a third ring of the three rings.

4. The apparatus of claim 1, wherein the set of retainers of each ray includes six retainers.

5. The apparatus of claim 4, wherein the plurality of tiles include six groups of tiles, each group of tiles having different sizes, a first group of tiles being sized to fit on a first ring of the six rings, a second group of tiles being sized to fit on a second ring of the six rings, a third group of tiles being sized to fit on a third ring of the six rings, a fourth group of tiles being sized to fit on a fourth ring of the six rings, a fifth group of tiles being sized to fit on a fifth ring of the six rings, and a sixth group of tiles being sized to fit on a sixth ring of the six rings.

6. The apparatus of claim 4, wherein each of the nine rays includes two ray portions configured to attach to each other, each portion of each ray being a different color than the other portion of the same ray.

7. The apparatus of claim 1, wherein the set of retainers of each ray includes nine retainers.

8. The apparatus of claim 7, wherein the plurality of tiles include nine groups of tiles, each group of tiles having different sizes, a first group of tiles being sized to fit on a first ring of the nine rings, a second group of tiles being sized to fit on a second ring of the nine rings, a third group of tiles being sized to fit on a third ring of the nine rings, a fourth group of tiles being sized to fit on a fourth ring of the nine rings, a fifth group of tiles being sized to fit on a fifth ring of the nine rings, a sixth group of tiles being sized to fit on a sixth ring of the nine rings, a seventh group of tiles being sized to fit on a seventh ring of the nine rings, an eighth group of tiles being sized to fit on a eighth ring of the nine rings, and a ninth group of tiles being sized to fit on a ninth ring of the nine rings.

9. The apparatus of claim 7, wherein each of the nine rays includes three portions configured to attach to each other, each portion of each ray being a different color than the other portions of the same ray.

10. The apparatus of claim 1, wherein each of the retainers is a post extending upwardly from the rays.

11. The apparatus of claim 10, wherein each tile includes an aperture shaped to fit around the post of the retainers.

12. The apparatus of claim 1, wherein each ray is configured to be removably attached to the centerpiece.

13. The apparatus of claim 1, wherein two adjacent cells are different color from each other.

14. The apparatus of claim 1, wherein the centerpiece is circular.

15. The apparatus of claim 1, further comprising a plurality of markers configured to identify a player of the game.

16. The apparatus of claim 15, wherein the markers are one of: washers configured to be placed on the retainers, stickers configured to be positioned on the tiles, or elastics configured to be positioned on the tiles.

17. The apparatus of claim 15, wherein each tile is personalized to a player of the game.

18. A non-transitory computer-readable medium comprising executable instructions for causing a computer system to provide an apparatus for playing a combinatorial number puzzle game, the apparatus comprising:
a framework having:
a centerpiece;
nine rays extending outwardly from the centerpiece, each ray having a set of retainers thereon, the retainers of each set of retainers being equally spaced apart along the ray, each retainer of each ray spaced apart from the centerpiece by a same distance forming a ring of retainers around the centerpiece, the retainers of the nine rays collectively forming at least three rings of retainers of the framework, the retainers of the rays also forming three cells of the framework, each cell being formed by three adjacent rays of the nine rays and three retainers on each of the three adjacent rays; and
a plurality of tiles, each tile having one of a number of colors, the number of colors being equal to a number of rays of the framework, each tile being configured to be retained on the retainers of the rays and placed according to its size.

19. (canceled)

20. (canceled)

21. (canceled)

22. (canceled)

23. (canceled)

24. (canceled)

25. (canceled)

26. A system for playing a combinatorial number puzzle game, the system comprising:
a board having:
a processor;
a data storage component in electrical communication with the processor;
a communication component in electrical communication with the processor, the communication component being configured to communicate with at least one external computing device; and
a display screen in electrical communication with the processor, the processor configured to display a framework, the framework having:
nine rays extending outwardly from the centerpiece, each ray having a set of spaces, the spaces of each set of spaces being equally spaced apart along the ray, each space of each ray spaced apart from the centerpiece by a same distance a respective space on each other ray to form a ring of spaces around the centerpiece, the spaces of the nine rays collectively forming at least three rings of spaces of the framework, the spaces of the rays also forming three cells of the framework, each cell being formed by three adjacent rays of the nine rays and three spaces on each of the three adjacent rays.

27. A non-transitory computer-readable medium comprising executable instructions for causing the system of claim 26 to provide the board on the display screen.
